(19) United States
(12) Patent Application Publication
(10) Pub. No.: US 2025/0393023 A1
(43) Pub. Date: Dec. 25, 2025

(54) USING NILRS TO OBTAIN UE LOCATIONS FOR RELATED DEVICES

(71) Applicant: T-Mobile USA, Inc., Bellevue, WA (US)

(72) Inventor: Christopher Bailey, Overland Park, KS (US)

(21) Appl. No.: 18/750,285

(22) Filed: Jun. 21, 2024

(51) Int. Cl. H04W 64/00; H04W 12/02; H04W 12/06

(52) U.S. Cl. CPC H04W 64/006; H04W 12/02; H04W 12/06

(57) ABSTRACT

Described herein is a network node configured to receive a request for a location of a user equipment (UE) from a related party having a pre-established relationship with the UE or to receive an indication from the UE that it is in a lost mode. The network node is further configured to send a network-initiated location request (NILR) to the UE in response to receiving the request for the location or the indication, to receive the location of the UE from the UE in response to the NILR, and to provide the location of the UE to the related party.

### BACKGROUND

Network-initiated location requests (NILRs) are a Third Generation Partnership Project (3GPP) standard approach for obtaining locations of user equipment (UEs) in emergency situations. The techniques used by the UEs and their networks result in locations with a high degree of specificity (e.g., to within thirty meters) that can be needed in emergency situations but tend not to be needed by other applications or uses. Further, because obtaining a highly specific user location impacts privacy of a UE's user, limitations on who or what can obtain such a location may be desirable. Currently, if a UE initiates an emergency communication, the UE is placed in emergency mode. In emergency mode, the UE will answer an NILR with the UE's location. If the UE is not in emergency mode, the UE will not answer the NILR.

### BRIEF DESCRIPTION OF THE DRAWINGS

The detailed description is set forth with reference to the accompanying figures. In the figures, the left-most digit(s) of a reference number identifies the figure in which the reference number first appears. The same reference numbers in different figures indicate similar or identical items.

FIG. 1 shows a network node of a telecommunications network sending a network-initiated location request (NILR) to a user equipment (UE) and providing the result to a related party having a pre-established relationship with the UE.

FIG. 2 illustrates a message diagram of messages exchanged between the network node, UE, and related party and associated actions taken by some or all of these devices, with the messages including an NILR sent from the network node to the UE in response to a request from the related party.

FIG. 3 illustrates a message diagram of messages exchanged between the network node, UE, and related party and associated actions taken by some or all of these devices, with the messages including an NILR sent from the network node to the UE in response to an indication from the UE that it is in a lost mode.

FIG. 4 is a flow diagram of an illustrative process for receiving a request for a location of the UE or an indication that the UE is in a lost mode, sending a NILR to the UE, receiving a location of the UE in response to the NILR, and providing the location to a related party having a pre-established relationship with the UE.

FIG. 5 is a schematic diagram of a computing device capable of implementing functionality of the network node, UE, or related party.

### DETAILED DESCRIPTION

This disclosure is directed in part to a network node of a telecommunications network sending a network-initiated location request (NILR) to a user equipment (UE) and providing the result to a related party having a pre-established relationship with the UE. The network node is configured to receive a request for a location of the UE from the related party or an indication from the UE that it is lost. The network node is further configured to send a NILR to the UE in response to that request or indication, receive a response that includes the location of the UE, and provide that location of the UE to the related party.

As used herein, a “related party” is any managing UE whose user has a parental, custodial, or guardian relationship to a user of the UE. When that relationship is configured on the managing UE and the UE (e.g., when they are in proximity to each other), the related party and UE are said to have a “pre-established relationship”. Record of that pre-established relationship may be configured on each of the related party and UE and may be defined and stored in a subscriber database of the telecommunications network.

In various implementations, the definition of the pre-established relationship stored in the subscriber database is used by the network node to authenticate the related party upon receiving the location request. For subsequent location requests from the related party within, e.g., a time period, the network node may skip re-authenticating the related party.

In further implementations, the UE receiving the NILR and answering it may be configured to enter into an emergency mode in response to instructions from the network node (sent, e.g., by the network node in response to the request for the location from the related party). Thus, the UE will be in emergency mode when receiving the NILR and will not reject the NILR. In additional or alternative implementations, the UE may be configured with a lost mode corresponding to a lost mode application or feature of the UE and may behave the same in the lost mode as in the emergency mode (i.e., the UE will answer NILR when in lost mode). Such a lost mode could either be triggered by user interaction with the lost mode application or feature of the UE or by instructions from the network node to enter into the lost mode.

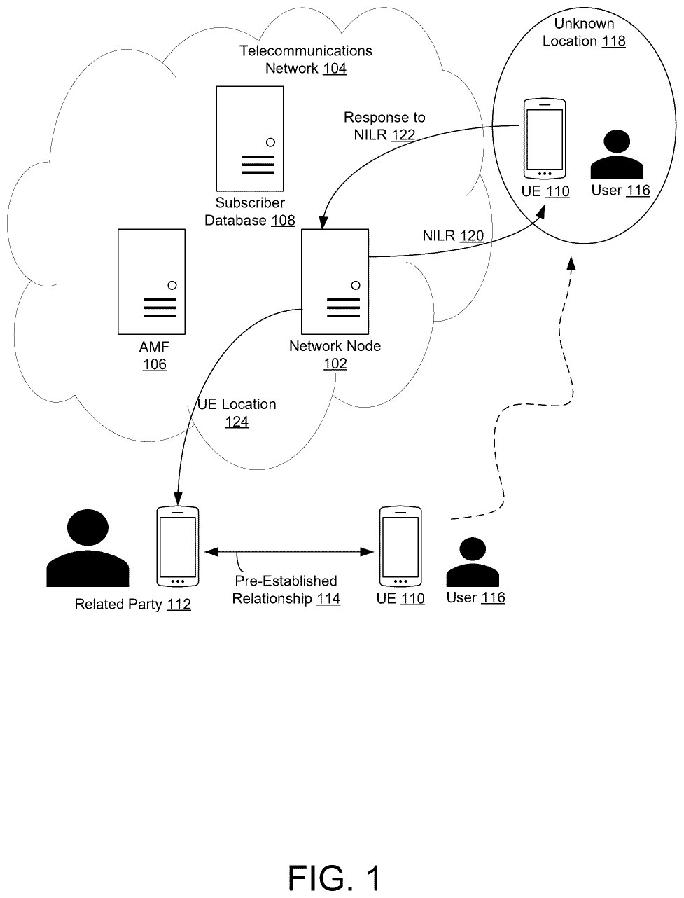

FIG. 1 shows a network node of a telecommunications network sending a NILR to a UE and providing the result to a related party having a pre-established relationship with the UE. As illustrated, network node 102 belongs to telecommunications network 104, and telecommunications network 104 also includes an access and mobility management function (AMF) 106 and subscriber database 108. The network node 102 may provide services, including location tracking, for UE 110 and may provide those locations to certain other UEs, such as a related party 112 that is in a pre-established relationship 114 with the UE 110. Upon the user 116 of the UE 110 moving with the UE 110 to a different location 118, where the user 116 may be lost, the related party 112 or user 116 (through a lost mode application) may cause the network node 102 to send a NILR 120 to the UE 110 and receive, in response, a message 122 that includes the location 118 of the UE 110. The network node 102 may then provide, at 124, the location 118 to the related party 112.

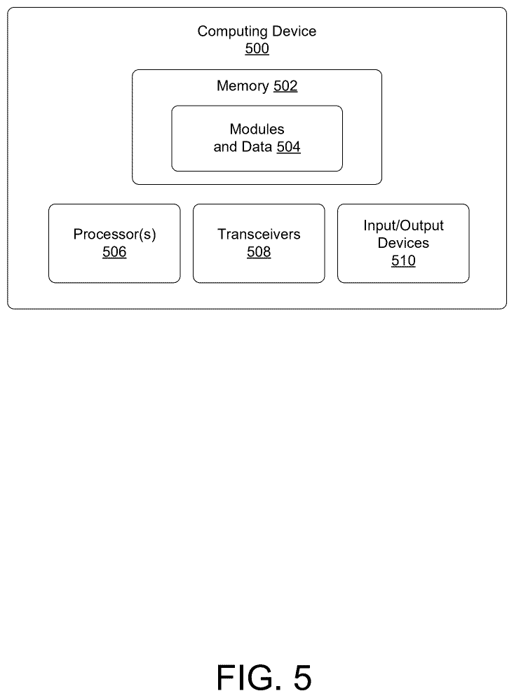

In various implementations, the network node 102 may be a gateway mobile location center (GMLC) or other network node of a same or different generation than a GMLC with similar or same functions. The network node 102 may communicate with the UE 110 and related party 112 through the AMF 106, at least initially, and may communicate with other nodes of the telecommunication network, such as the subscriber database 108. The network node 102 may be any sort of computing device, and an example computing device capable of implementing the network node 102 is illustrated in FIG. 5 and described herein in further detail.

The telecommunications network 104 may be any generation of technology, such as Fourth Generation (4G), Fifth Generation (5G), Sixth Generation (6G), or an earlier or later generation of technology. The telecommunications network 104 may include radio access networks (RANs) and a core network. The RANs may include base stations offering wireless communication over radio waves and may be connected through a backhaul to the core network. The core network in turn may include at least the network node 102, AMF 106, and subscriber database 108. The core network may also include an Internet Protocol (IP) multimedia subsystem (IMS) to enable packet-based communications across the core network.

The subscriber database 108 may be a home subscriber server (HSS), a unified data management (UDM) node and unified data register (UDR), or other data store for information about subscribers to telecommunication services offered by the operator of the telecommunications network 104. Such information can include a unique identifier for each UE of a subscriber (e.g., a mobile station international subscriber directory number (MSISDN)), as well as information about relationships to other users of a subscriber account or to other accounts. Such a relationship could signify that a subscriber is a guardian, parent, or custodian of the other users. For example, the subscriber could be a parent with one UE and the other user could be a child with her own UE under management of the parent's UE. In terminology used herein, the child would be an example of the user 116, the child's UE an example of UE 110, and the parent and/or parent's UE an example of the related party 112. A representation of the “pre-established relationship 114” between the related party 112 and the user 116/UE 110 may be stored and defined in the subscriber database 108. In instances in which legal consent of the user 116 is legally required to share the location of the UE 110 with the related party 112, the “pre-established relationship 114” may only be established between the related party 112 and the user 116/UE 110 after the user 116 has legally consented in advance to the sharing of the location of the UE 110 with the related party 112. For example, the user 116 may use a user interface of the UE 110 to affirmatively provide the consent to the telecommunications network 104. In some instances, the user 116 may provide the consent via the user interface of the UE 110 in response to a prompt that is generated by the network node 102 after a request to have access to the location of the UE 110 is initiated by the related party 112 to the network node 102.

In various implementations, the UE 110 and the related party 112 (also referred to as the managing UE of the related party 112) may each be any sort of mobile telecommunications device. UE 110 and the related party 112 may each be a cellular phone, a tablet computer, a watch, goggles, an Internet-of-Things (IoT) device, a personal computer (PC), a gaming device, or any sort of device capable of wireless and/or cellular communication with telecommunications network. UE 110 and the related party 112 may each be a device of a user (e.g., user 116 or the user comprising the related party 112) who subscribes for telecommunication services with a network operator of the telecommunications network 104. An example computing device capable of implementing the UE 110 or the related party 112 is also described in greater detail herein with respect to FIG. 5.

The related party 112 is used herein to designate both the managing UE and its user or simply the managing UE or just the user, depending on context. For example, if a relationship is described as being established between the related party 112 and the UE 110, the related party 112 is referring to the managing UE. If the related party 112 is referred to as a subscriber, the related party 112 is referring to the user of the managing UE. The UE of the related party 112 is referred to as a managing UE because it has a managing relationship with the UE 110 of the user 116.

In various implementations, the pre-established relationship 114 refers to the relationship between the managing UE/related party 112 and the UE 110, to the data representation of that relationship, or both. The pre-established relationship 114 can be established when the related party 112 and UE 110 are in proximity to each other via, e.g., physical contact of the devices or a connection (e.g., Bluetooth) between the devices. Once established, the related party 112, the UE 110, or both may notify the telecommunications network 104, which may define and store information about the pre-established relationship 114 in the subscriber database 108.

At some later time, the user 116 may move with the UE 110 to a different location 118. The user 116 may not know where the user 116 is or may be where the user 116 is not supposed to be. To resolve this problem, the user 116 can trigger a lost mode, the related party 112 can request a location of the UE 110, or both. If the UE 110 is configured with a lost mode application or feature and the user 116 becomes aware that he or she is lost, the user 116 can activate the lost mode application or feature on the UE 110 through, e.g., a user interface of the UE 110. Activation of the lost mode application or feature may result in the UE 110 placing itself in a lost mode, which may operate like an emergency mode with respect to answering NILRs. The UE 110 may then notify the network node 102 or other node of the telecommunications network 104 that the UE 110 has placed itself in a lost mode.

In some implementations, the UE 110 may not have a lost mode application or feature, or the user 116 may not be aware that he or she is lost (e.g., if the user 116 is a senior citizen suffering from dementia). When the related party 112 realizes that the user 116 is lost, missing, or otherwise not where the user 116 is expected to be, the related party 112 can send a request for the location of the UE 110 to the network node 102 or other node of the telecommunications network 104. Such a request may be initiated through a user interface of the managing UE of the related party 112, e.g., a user interface associated with managing devices that the related party 112 has a parent, custodian, or guardian relationship with.

In some implementations, upon receiving the request for the location and prior to sending an NILR to the UE 110, the network node 102 may authenticate the related party 112 using, for example, the information stored in the subscriber database 108. Such authentication may confirm that the related party 112 is who it claims to be and that the related party 112 has the pre-established relationship 114 with the UE 110.

Upon authenticating the related party 112, the network node 102 may send instructions to the UE 110 placing the UE 110 in an emergency mode or lost mode, either of which would enable the UE 110 to respond to the NILR with its location.

With the UE 110 in an emergency mode or lost mode, placed there by activating of a lost mode by the user 116 or by the network node 102 in response to a related party 112 request, the network node 102 may send an NILR, at 120, to the UE 110. The UE 110 may then respond to the NILR, at 122, with its location. Such a response could be sent using location positioning protocol (LPP), observed time difference of arrival (OTDOA), or a session initiation protocol (SIP) message to the network node 102.

In some implementations, the network node 102 may receive multiple locations for the UE 110, such as multiple answers to an NILR, or locations for the UE 110 in addition to that sent by an answer to the NILR. In such implementations, the network node 102 can determine a location uncertainty measurement for each of the received locations and select the location with the best location uncertainty measurement (e.g., if lower numbers indicate lower location uncertainty and higher numbers indicate higher location uncertainty, a best location uncertainty measurement may be the lowest).

In various implementations, the UE 110 may be configured to exit the emergency mode or lost mode in response to some action or trigger. For example, the UE 110 may be configured to exit the emergency mode or lost mode after sending a response to the NILR. Alternatively or additionally, the UE 110 may start a timer on entering the emergency mode or lost mode and exit emergency mode or lost mode upon expiration of the timer. Further, the UE 110 could start or restart a timer with each NILR received or answer sent and exit emergency mode or lost mode upon expiration of the timer. In additional examples, the UE 110 could be configured to exit the emergency mode or lost mode responsive to instructions from the network node 102 to exit the emergency mode or lost mode.

In further implementations, the network node 102 may be configured to allow the related party 112 to submit multiple location requests for the UE 110 within a time period (either an overall time period from the first request or time periods after each request) without reauthenticating the related party 112. When the UE 110 also stays in the emergency mode or lost mode after answering the NILR, the network node 102 is able to submit second and subsequent NILRs to the UE 110 without needing to send instructions to enter the emergency mode or lost mode. This ability to repeatedly query for the location 118 of the UE 110 may be useful when the related party 112 is moving towards the location 118 and the UE 110/user 116 are continually moving or changing locations.

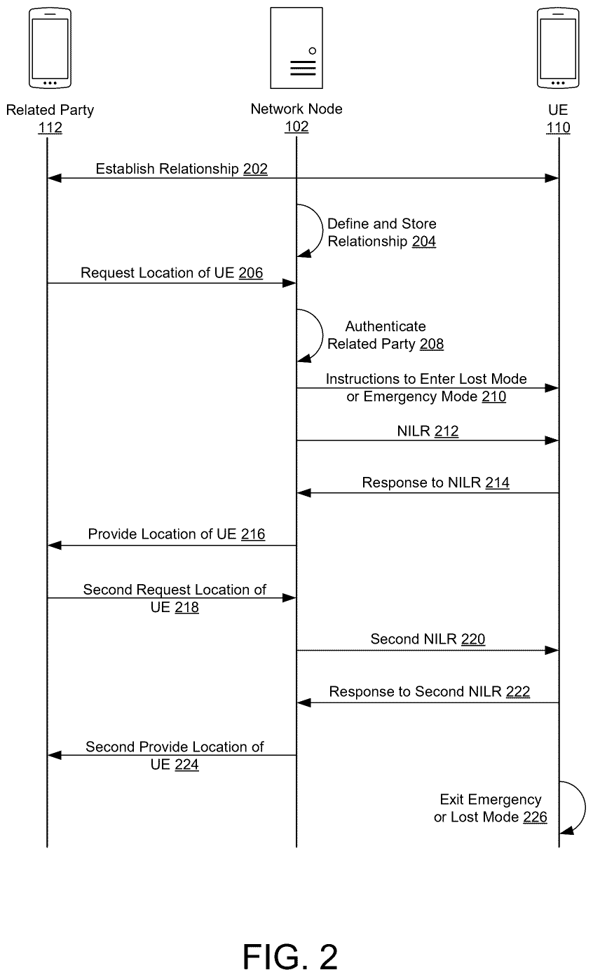

FIG. 2 illustrates a message diagram of messages exchanged between the network node, UE, and related party and associated actions taken by some or all of these devices, with the messages including an NILR sent from the network node to the UE in response to a request from the related party. As illustrated, the related party 112 and UE 110 may establish a relationship at 202 and the network node 102 may define and store information about the relationship at 204 (e.g., in a subscriber database 108). At some later time, perhaps when a user of the UE 110 goes missing, the related party 112 sends a request 206 for the location of the UE 110. The network node 102 may then authenticate the related party 112 at 208 (using, e.g., the stored information about the relationship between the related party 112 and UE 110) and, if the related party 112 is authenticated, send instructions 210 to the UE 110 to enter a lost mode or emergency mode. The network node 102 then sends an NILR 212 to the UE 110 which, having entered the lost mode or emergency mode, sends a response 214 to the NILR to the network node 102. The network node 102 then sends a message 216 providing the location of the UE 110 to the related party 112. In some implementations, further requests and responses may follow; the related party 112 sends a second request 218 for the location of the UE 110, the network node 102 sends a second NILR 220, the UE 110 sends a second response 222 to the NILR to the network node 102, and the network node 102 sends a second message 224 providing a location of the UE 110 to the related party 112. Based on a timer, instructions from the network node 102, or sending a response to an NILR, the UE 110 may exit the lost mode or emergency mode at 226.

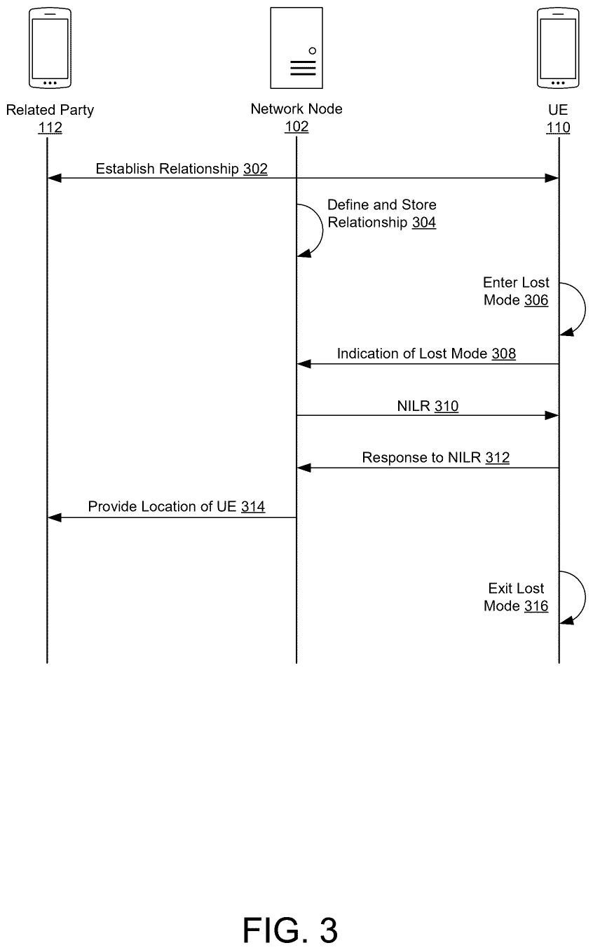

FIG. 3 illustrates a message diagram of messages exchanged between the network node, UE, and related party and associated actions taken by some or all of these devices, with the messages including an NILR sent from the network node to the UE in response to an indication from the UE that it is in a lost mode. As illustrated, the related party 112 and UE 110 may establish a relationship at 302 and the network node 102 may define and store information about the relationship at 304 (e.g., in a subscriber database 108). At some later time, the user of the UE 110 may realize that he or she is lost and activate a lost mode application or feature of the UE 110, at 306. The UE 110 then enters the lost mode and sends an indication 308 to the network node 102 that the UE 110 has entered a lost mode. The network node 102 then sends an NILR 310 to the UE 110 which, having entered the lost mode, sends a response 312 to the NILR to the network node 102. The network node 102 then sends a message 314 providing the location of the UE 110 to the related party 112, letting a trusted person know of the lost user's location. The UE 110 may then exit the lost mode, at 316, based on a timer, instructions from the network node 102, or sending a response to an NILR.

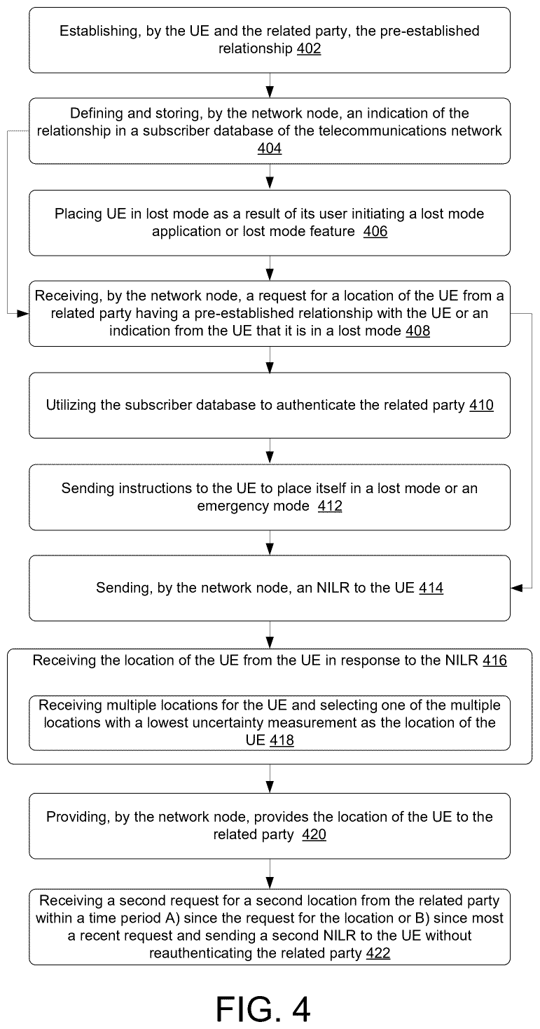

FIG. 4 illustrates an example process. This process is illustrated as logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 4 is a flow diagram of an illustrative process for receiving a request for a location of the UE or an indication that the UE is in a lost mode, sending a NILR to the UE, receiving a location of the UE in response to the NILR, and providing the location to a related party having a pre-established relationship with the UE. As illustrated at 402, a UE and a related party may establish a relationship (i.e., the “pre-established relationship). The related party may include a managing UE whose user has a parental, custodial, or guardian relationship to a user of the UE. Further, the relationship of the related party and the UE may be created when the managing UE and the UE are in proximity to each other (e.g., as shown in FIG. 1).

At 404, a network node may receive notification of the relationship between the related party and the UE and may define and store an indication of the relationship in a subscriber database of the telecommunications network.

In some implementations, at 406, the UE may initiate the NILR. In such implementations, the user of the UE may place the UE in lost mode as a result of its user initiating a lost mode application or lost mode feature. The UE may then send an indication to the telecommunications network that the UE is in lost mode.

At 408, the network node (e.g., a GMLC) may receive A) a request for a location of the UE from a related party having a pre-established relationship with the UE or B) an indication from the UE that it is in a lost mode.

In some implementations, at 410, in response to receiving the request from the related party, the network node may utilize the subscriber database to authenticate the related party. At 412, the network node may then send instructions to the UE to place itself in a lost mode or an emergency mode.

At 414, in response to receiving the request or the indication, the network node sends a NILR to the UE.

At 416, the network node receives the location of the UE from the UE in response to the NILR. In some implementations, at 418, the network node may receive multiple locations for the UE and select one of the multiple locations with a lowest uncertainty measurement as the location of the UE. Also, in some implementations, the emergency mode or the lost mode at the UE may turn off after sending a response to the NILR, after expiration of a timer, or in response to instructions from the network node to turn off the emergency mode or the lost mode.

At 420, the network node provides the location of the UE to the related party.

In some implementations, at 422, the network node may receive a second request for a second location from the related party within a time period A) since the request for the location or B) since most a recent request and may send a second NILR to the UE without reauthenticating the related party.

FIG. 5 is a schematic diagram of a computing device capable of implementing functionality of the network node, UE, or related party. As shown, the computing device 500 includes a memory 502 storing modules and data 504, processor(s) 506, transceivers 508, and input/output devices 510.

In various examples, the memory 502 can include system memory, which may be volatile (such as RAM), non-volatile (such as ROM, flash memory, etc.) or some combination of the two. The memory 502 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information.

The memory 502 can include one or more software or firmware elements, such as computer-readable instructions that are executable by the one or more processors 506. For example, the memory 502 can store computer-executable instructions associated with modules and data 504. The modules and data 504 can include a platform, operating system, and applications, and data utilized by the platform, operating system, and applications. Further, the modules and data 504 can implement any of the functionality for the network node 102, UE 110, related party 112, or any other node/device described and illustrated herein.

In various examples, the processor(s) 506 can be a central processing unit (CPU), a graphics processing unit (GPU), or both CPU and GPU, or any other type of processing unit. Each of the one or more processor(s) 506 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 506 may also be responsible for executing all computer applications stored in the memory 502, which can be associated with types of volatile (RAM) and/or nonvolatile (ROM) memory.

The transceivers 508 can include modems, interfaces, antennas, Ethernet ports, cable interface components, and/or other components that perform or assist in exchanging wireless communications, wired communications, or both.

While the computing device need not include input/output devices 510, in some implementations it may include one, some, or all of these. For example, the input/output devices 510 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 510 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 510 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

Although features and/or methodological acts are described above, it is to be understood that the appended claims are not necessarily limited to those features or acts. Rather, the features and acts described above are disclosed as example forms of implementing the claims.

What is claimed is:

1. A method comprising:
receiving, by a network node of a telecommunications network, a request for a location of a user equipment (UE) from a related party having a pre-established relationship with the UE or an indication from the UE that it is in a lost mode;
in response to receiving the request or the indication, sending, by the network node, a network-initiated location request (NILR) to the UE;
receiving, by the network node, the location of the UE from the UE in response to the NILR; and
providing, by the network node, the location of the UE to the related party.

2. The method of claim 1, wherein the related party includes a managing UE whose user has a parental, custodial, or guardian relationship to a user of the UE.

3. The method of claim 2, wherein the pre-established relationship of the related party and the UE was created when the managing UE and the UE were in proximity to each other.

4. The method of claim 1, wherein the pre-established relationship is defined and stored in a subscriber database of the telecommunications network.

5. The method of claim 4, further comprising, in response to receiving the request from the related party, utilizing the subscriber database to authenticate the related party and performing the sending of the NILR based on the authenticating.

6. The method of claim 5, further comprising:
receiving a second request for a second location from the related party within a time period A) since the request for the location or B) since most a recent request; and
sending a second NILR to the UE without reauthenticating the related party.

7. The method of claim 1, wherein the network node is a gateway mobile location center (GMLC).

8. The method of claim 1, wherein the receiving the request for the location or the indication from the UE comprises receiving the request, and the method further comprises sending instructions to the UE to place itself in a lost mode or an emergency mode.

9. The method of claim 1, wherein the UE is placed in the lost mode by its user initiating an application or feature and sending the indication to the telecommunications network that the UE is in the lost mode.

10. The method of claim 1, further comprising receiving multiple locations for the UE and selecting one of the multiple locations with a lowest uncertainty measurement as the location of the UE.

11. The method of claim 1, wherein an emergency mode or the lost mode at the UE is exited after the UE sends a response to the NILR, after expiration of a timer, or in response to instructions from the network node to exit the emergency mode or the lost mode.

12. A network node of a telecommunications network, the network node comprising:
one or more processors; and
programming instructions that, when executed by the one or more processors, cause the network node to perform operations including:
receiving a request for a location of a user equipment (UE) from a related party having a pre-established relationship with the UE or an indication from the UE that it is in a lost mode;
in response to receiving the request or the indication, sending a network-initiated location request (NILR) to the UE;
receiving the location of the UE from the UE in response to the NILR; and
providing the location of the UE to the related party.

13. The network node of claim 12, wherein the related party is a managing UE whose user has a parental, custodial, or guardian relationship to a user of the UE.

14. The network node of claim 12, wherein the pre-established relationship is defined and stored in a subscriber database of the telecommunications network, and the operations further include, in response to receiving the request from the related party:
utilizing the subscriber database to authenticate the related party, and
performing the sending of the NILR based on the authenticating.

15. The network node of claim 12, wherein the receiving the request for the location or the indication from the UE comprises receiving the request, and the operations further include sending instructions to the UE to place itself in a lost mode or an emergency mode.

16. The network node of claim 12, wherein the UE is placed in the lost mode by its user initiating an application or feature and sending the indication to the telecommunications network that the UE is in the lost mode.

17. The network node of claim 12, wherein an emergency mode or the lost mode at the UE is exited after sending a response to the NILR, after expiration of a timer, or in response to instructions from the network node to exit the emergency mode or the lost mode.

18. A non-transitory computer storage medium having programming instructions stored thereon that, when executed by one or more processors of a network node of a telecommunications network, cause the network node to perform operations comprising:
receiving a request for a location of a user equipment (UE) from a related party having a pre-established relationship with the UE or an indication from the UE that it is in a lost mode;
in response to receiving the request or the indication, sending a network-initiated location request (NILR) to the UE;
receiving the location of the UE from the UE in response to the NILR; and
providing the location of the UE to the related party.

19. The non-transitory computer storage medium of claim 18, wherein the receiving the request for the location or the indication from the UE comprises receiving the request, and the operations further comprise sending instructions to the UE to place itself in a lost mode or an emergency mode.

20. The non-transitory computer storage medium of claim 18, wherein the UE is placed in the lost mode by its user initiating an application or feature and sending the indication to the telecommunications network that the UE is in the lost mode.
